(19) United States
(12) Patent Application Publication
(10) Pub. No.: US 2011/0211718 A1
(43) Pub. Date: Sep. 1, 2011

(54) HEARING AID

(75) Inventors: Swee Kim Chua, Singapore (SG); Wee Haw Koo, Singapore (SG)

(73) Assignee: SIEMENS MEDICAL INSTRUMENTS PTE. LTD., Singapore (SG)

(21) Appl. No.: 13/127,127

(22) PCT Filed: Oct. 31, 2008
(86) PCT No.: PCT/SG08/00416

§ 371 Date: May 2, 2011

(51) Int. Cl. H04R 25/00

(52) U.S. Cl. 381/323

(57) ABSTRACT

In an embodiment, a hearing aid (102) is provided. The hearing aid (102) may include a hearing aid housing (104), the hearing aid housing (104) including a receiving portion; a battery chamber housing (106) coupled to the hearing aid housing; and a lock (112) positioned on the battery chamber housing (106). The lock (112) may include a first engaging portion; and a second engaging portion (116) coupled to the first engaging portion, the first engaging portion may include a material of a higher tensile strength than the second engaging portion; wherein the first engaging portion may be configured to be movable relative to the battery chamber housing (106) such that the first engaging portion may be coupled to the receiving portion to lock the battery chamber housing (106).

Embodiments relate to a hearing aid.

A hearing aid is usually fitted in or behind the ear of the user to amplify the sound for the user. Some popular types of hearing aids include behind-the-ear (BTE) hearing aids, in-the-ear (ITE) hearing aids, in-the-canal (ITC) hearing aids, completely-in-the-canal (CIC) hearing aids, etc.

A hearing aid usually includes a hearing aid housing within which a microphone for collecting sound waves, a signal processing circuit (also referred to as a speech processing circuit) for processing the collected sound waves and a loudspeaker (which may also be referred to as a receiver in the field of hearing aids) may be housed. To provide power for the microphone, the signal processing circuit and the loudspeaker, the hearing aid usually includes a battery chamber housing, also referred to as a battery door, coupled to the hearing aid housing to receive a battery. The hearing aid may also include an ear hook coupled to the hearing aid housing to fix the hearing aid housing when worn by a user.

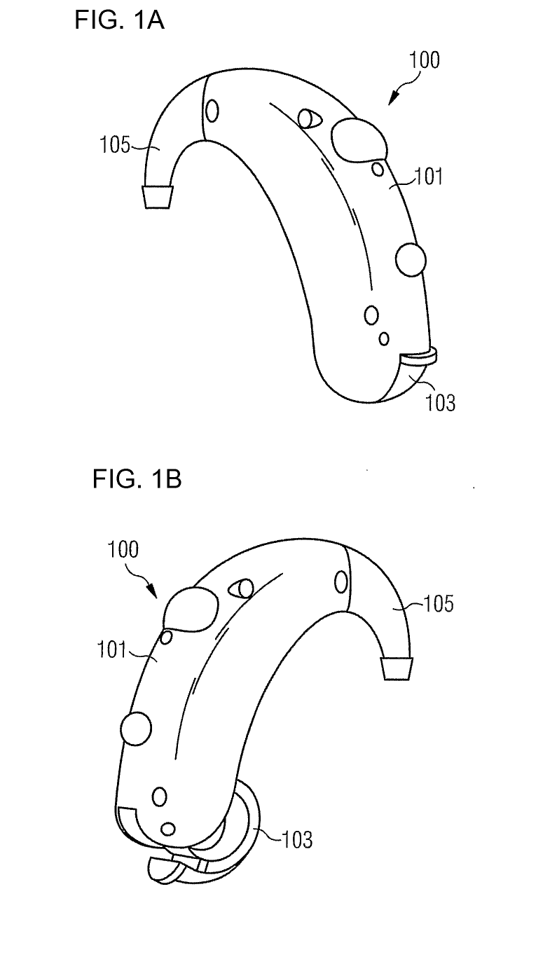

FIG. 1A shows a conventional behind-the-ear hearing aid 100 and FIG. 1B shows the conventional behind-the-ear hearing aid 100 with open battery chamber housing 103. The hearing aid 100 may include a hearing aid housing 101, a battery chamber housing 103 coupled to the hearing aid housing 101 and an ear hook 105 coupled to the hearing aid housing 101 to fix the hearing aid housing 101 when worn by a hearing aid user.

The hearing aid housing 101 may accommodate a microphone, a signal processing circuit and a loudspeaker. The battery chamber housing 103 may be pivoted into or out of the hearing aid housing 101. The battery chamber housing 103 may receive a battery (not shown) used for driving the hearing aid 100.

The hearing aid 100 may also include a lock (not shown) made with either plastic or metal. Due to the small size of the hearing aid 100, the lock is usually small in size. It may be desired to improve the safety of the hearing aid lock while keeping the flexibility thereof.

In various embodiments, a hearing aid may be provided, which may include a lock which may provide an increased latching strength for the hearing aid user.

An embodiment relates to a hearing aid. The hearing aid may include a hearing aid housing, the hearing aid housing including a receiving portion; a battery chamber housing coupled to the hearing aid housing; and a lock positioned on the battery chamber housing. The lock may include a first engaging portion; and a second engaging portion coupled to the first engaging portion, the first engaging portion may include a material of a higher tensile strength than the second engaging portion; wherein the first engaging portion may be configured to be movable relative to the battery chamber housing such that the first engaging portion may be coupled to the receiving portion to lock the battery chamber housing. The higher tensile strength of the first engaging portion when compared to the second engaging portion may provide for an increased latching strength to the lock for the hearing aid user.

In an embodiment, the first engaging portion may include a cylindrical rod. The first engaging portion may also include an elongated portion of any other suitable shape. It should be mentioned that another suitable shape of the first engaging portion may also be provided in another embodiment.

In an embodiment, the first engaging portion may include a metallic material. The first engaging portion may also include any other suitable material which may be able to provide a high tensile strength for locking of the battery chamber housing.

In an embodiment, the second engaging portion may include a first portion and a second portion. The second portion may be of a larger dimension as compared to the first portion. The second portion of the second engaging portion may be positioned adjacent and/or in connection with the first portion of the second engaging portion. The second engaging portion may also include any suitable number of portions depending on design requirements.

In an embodiment, the first portion of the second engaging portion may substantially surround the first engaging portion.

In an embodiment, the second portion of the second engaging portion may include a first surface and a second surface, the second surface may be positioned opposite to the first surface. The first surface and the second surface may be planar surfaces or any suitable surfaces.

In an embodiment, the second portion of the second engaging portion may include at least one recess and at least one protrusion on the first surface. The first surface of the second portion of the second engaging portion may include any suitable number of recesses and protrusions depending on design requirements. Each recess may be positioned between two protrusions. Each of the recess and two protrusions combination may be configured to allow for a hearing aid user to insert a suitable device, for example a screw driver or a device with a sharp end, into the recess to lock or unlock the battery chamber housing. The dimensions of the recess may be configured according to the dimension of the suitable device to be inserted therein.

In an embodiment, the second portion of the second engaging portion may include a marking on the at least one protrusion on the first surface. Each or all the protrusions may be configured to allow printing on the protrusions so as to provide an indication to the hearing aid user the position for the insertion of the screw driver to lock or unlock the battery chamber housing. The marking on the protrusion may be performed by any suitable printing processes, for example by laser marking. Typically, the screw driver may be inserted into the recess between two protrusions with marking.

In an embodiment, the battery chamber housing may include at least one protrusion on the battery chamber housing. The number of protrusions on the battery chamber housing may dependent on design or user requirements. The at least one protrusion may be in contact with the lock when the lock is positioned on the battery chamber housing.

In an embodiment, the second portion of the second engaging portion may include at least one recess and at least one protrusion on the second surface. The second surface of the second portion of the second engaging portion may include any suitable number of recesses and protrusions depending on design requirements. Each recess may be positioned between two protrusions. The combination of recesses and protrusions on the second surface of the second portion with the pressure of the recesses and protrusions or the lock in general against the at least one protrusion on the battery chamber housing provide for a “click” latching feel when the second portion moves relative to the battery chamber housing when the hearing aid user locks or unlocks the battery chamber housing. Therefore, the plurality of recesses and protrusions may be configured to provide an indication to the hearing aid user of the locking status when the hearing aid user locks or unlocks the battery chamber housing. This combination of the plurality of recesses and protrusions on the second surface of the second portion of the second engaging portion may also be termed as “a tooth slider”.

In an embodiment, the second engaging portion may include a plastic material or any other suitable material which may allow for configuring the second engaging portion to include the plurality of recesses and protrusions. The second engaging portion may be a plastic material which may be molded to the desired shape. The second engaging portion may also include any suitable material which may allow for printing of the marking or for a change of a color of the material.

In an embodiment, the receiving portion may include a first recess and a second recess. The first recess may be connected to the second recess. The second recess may be of a larger surface area compared to the first recess such that the first recess may be situated within the second recess. The first recess may extend to a depth greater than the second recess to accommodate the first engaging portion. The first recess may also be the same as the second recess.

In an embodiment, the first recess may include a through hole or a blind hole. The recess may be of any suitable shape depending on design requirements. A through hole refers to a hole that may be made completely through the hearing aid housing. In other words, a through hole may be a hole that goes all the way through the hearing aid housing. In contrast, a blind hole may be a hole which does not go all the way through the hearing aid housing.

In an embodiment, the second recess may include a slot. The second recess may have a rectangle shape or any suitable shape, corresponding to the second engaging portion. The second recess may also be a through slot or a blind slot depending on design requirements.

In an embodiment, the first recess may be of a complementary shape to the first engaging portion and the second recess may be of a complementary shape to the second engaging portion.

The first recess and the second recess may be of any suitable shape or dimensions depending on user requirements.

In an embodiment, the first engaging portion may be coupled to the first recess and the second engaging portion may be coupled to the second recess when the lock may be coupled to the receiving portion to lock the battery chamber housing.

In an embodiment, the hearing aid may include a behind-the-ear hearing aid.

In an embodiment, the hearing aid may further include an ear hook coupled to the hearing aid housing.

In an embodiment, the hearing aid housing may be configured to receive the battery chamber housing. For example, the battery chamber housing may be used to house a battery to provide power for the microphone, signal processing circuit, loudspeaker, and other suitable components or circuits in the hearing aid, etc.

In an embodiment, the battery chamber housing may be pivotally mounted or mounted via any suitable means on the hearing aid housing. The battery chamber housing may also include a notch for ease of opening and closing the battery chamber housing. For example, the battery chamber housing may be pivoted out of the hearing aid housing to put in or to take out a battery in the battery chamber housing, and may then be pivoted back into the hearing aid housing.

In an embodiment, the battery chamber housing may include a partially circular outer shape. The shape of the battery chamber housing may correspond with the shape of the battery so as to fix the battery within the hearing aid housing when the battery chamber housing may be closed. The battery chamber housing may include any other suitable shape depending on design requirements.

In an embodiment, the hearing aid housing may include a plastic material or any other suitable material.

In an embodiment, the battery chamber housing may include a plastic material or any other suitable material.

In an embodiment, the hearing aid housing may be of the same material as the battery chamber housing. Use of the same material for both the hearing aid housing and the battery chamber housing may provide for ease of fabrication for the hearing aid housing and the battery chamber housing.

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A shows a perspective view of a conventional behind-the-ear hearing aid and FIG. 1B shows a perspective view of the conventional behind-the-ear hearing aid with open battery chamber housing;

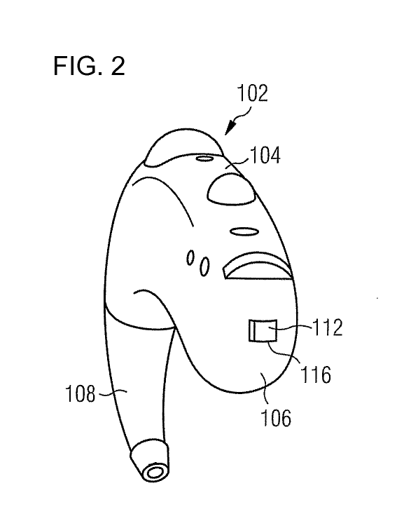

FIG. 2 shows a perspective view of a hearing aid according to an embodiment;

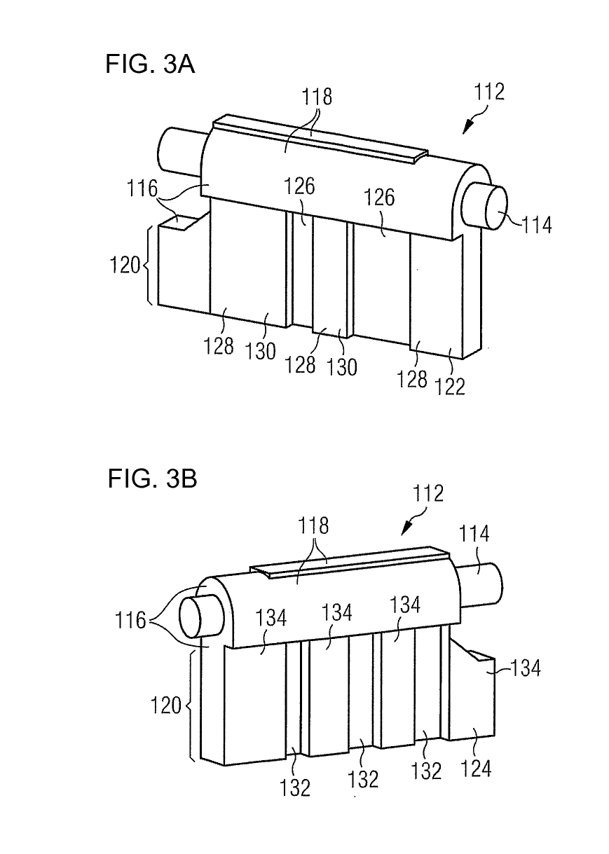

FIG. 3A and FIG. 3B show a respective front view and back view of a lock positioned in the hearing aid of FIG. 2 according to an embodiment;

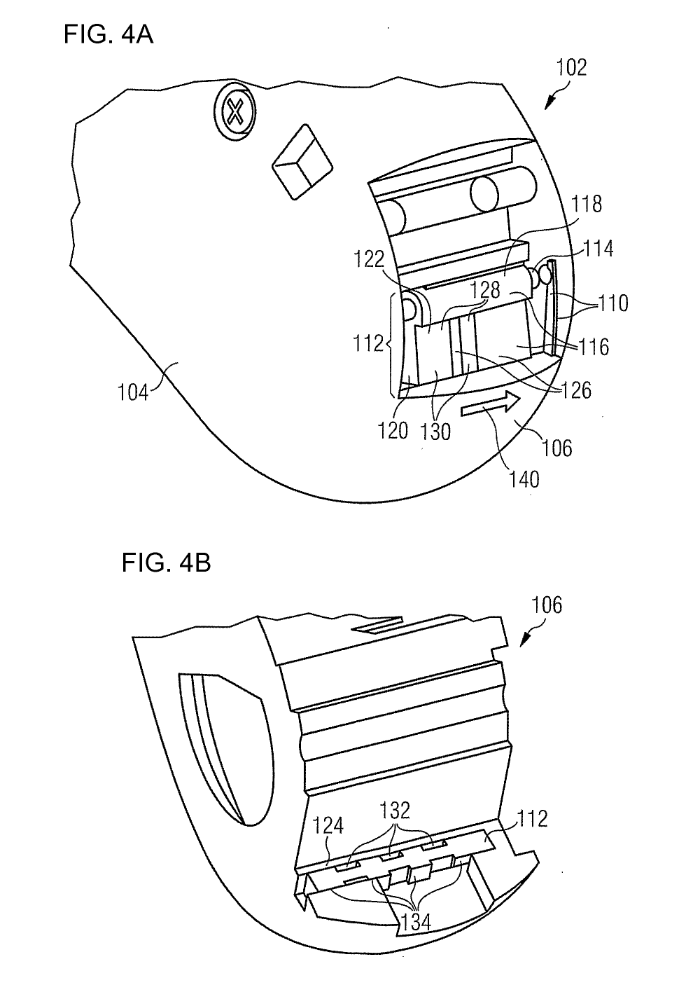

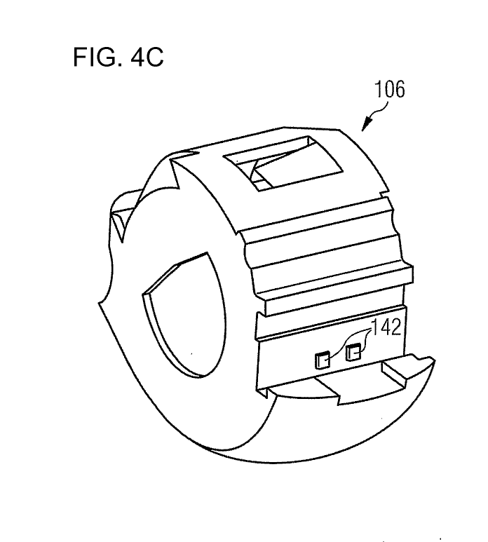

FIG. 4A shows a perspective view of a hearing aid with close battery chamber housing and with an exposed front view of a lock positioned in the battery chamber housing according to an embodiment, FIG. 4B shows an open battery chamber housing and with an exposed top view of a lock positioned in the battery chamber housing according to an embodiment and FIG. 4C shows an open battery chamber housing without the lock according to an embodiment; and

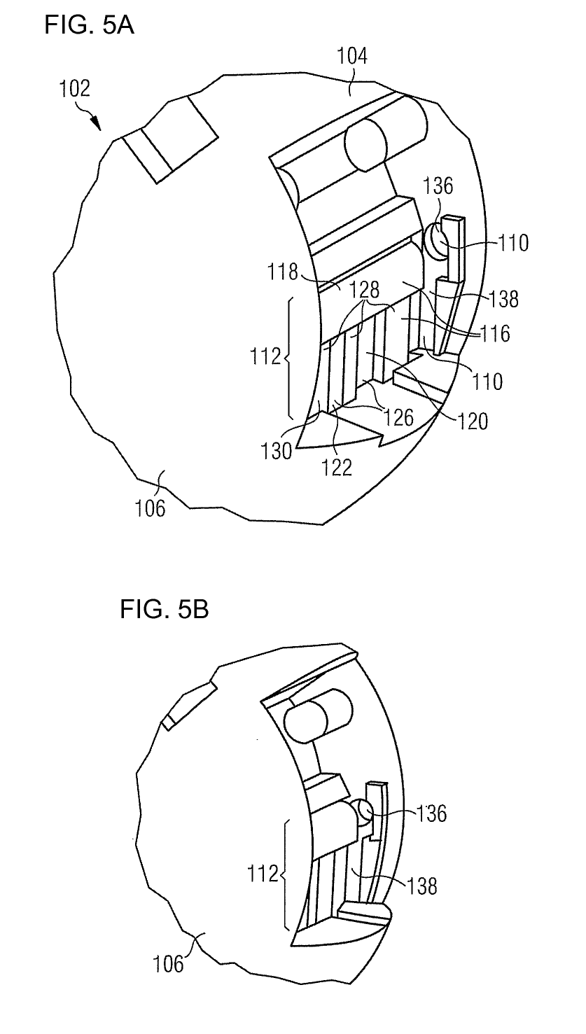

FIG. 5A shows a perspective view of a hearing aid with close battery chamber housing and a first recess in the hearing aid housing being a blind hole according to an embodiment and FIG. 5B shows a perspective view of a hearing aid with close battery chamber housing and a first recess in the hearing aid housing being a through hole according to an embodiment.

FIG. 2 shows a perspective view of a hearing aid 102 according to an embodiment.

By way of example, FIG. 2 shows a behind-the-ear hearing aid 102. The hearing aid 102 may include a hearing aid housing 104, the hearing aid housing 104 including a receiving portion (not shown). The hearing aid 102 may further include a battery chamber housing 106 coupled to the hearing aid housing 104 and a lock 112 positioned on the battery chamber housing 106. The lock 112 may include a first engaging portion (not shown) and a second engaging portion 116 coupled to the first engaging portion. The first engaging portion may include a material of a higher tensile strength than the second engaging portion 116. The first engaging portion may be configured to be movable relative to the battery chamber housing 106 such that the first engaging portion may be coupled to the receiving portion to lock the battery chamber housing 106.

The hearing aid 102 may further include an ear hook 108 coupled to the hearing aid housing 104. The ear hook 108 may be used to fix the hearing aid housing 104 when worn by a hearing aid user.

The hearing aid housing 104 may be configured to receive the battery chamber housing 106.

The hearing aid housing 104 may include a plastic material or any other suitable material. The battery chamber housing 106 may include a plastic material or any other suitable material. The hearing aid housing 104 may be of the same material as the battery chamber housing 106.

In an embodiment, the hearing aid housing 104 may accommodate a microphone, a signal processing circuit and a loudspeaker, for example, as well as other as such conventional components of a hearing aid 102. The battery chamber housing 106 may be pivoted into or out of the hearing aid housing 104. The battery chamber housing 106 may receive a battery (not shown) used for driving the hearing aid 102.

FIG. 3A and FIG. 3B show a respective front view and back view of a lock 112 positioned in the hearing aid 102 of FIG. 2 according to an embodiment.

The lock 112 may include a first engaging portion 114 and a second engaging portion 116 coupled to the first engaging portion 114, the first engaging portion 114 may include a material of a higher tensile strength than the second engaging portion 116.

The first engaging portion 114 may include a cylindrical rod or an elongated portion of any other suitable shape. The first engaging portion 114 may include a metallic material or any other suitable material.

The second engaging portion 116 may include a first portion 118 and a second portion 120. The first portion 118 of the second engaging portion 116 may substantially surround the first engaging portion 114. The second portion 120 of the second engaging portion 116 may be positioned adjacent and/or in connection with the first portion 118 of the second engaging portion 116. The second portion 120 of the second engaging portion 116 may include a first surface 122 and a second surface 124, the second surface 124 being positioned opposite to the first surface 122.

From the front view of the lock 112 in FIG. 3A, the second portion 120 of the second engaging portion 116 may include two recesses 126 and three protrusions 128 on the first surface 122. The second portion 120 of the second engaging portion 116 may include a marking 130 on two of the three protrusions 128 on the first surface 122. One of the two recesses 126 may be positioned between the two protrusions 128 with markings 130 so as to provide an indication to the hearing aid user the position to insert a suitable device, for example a screw driver, in order to lock or unlock the battery chamber housing 106.

From the back view of the lock 112 in FIG. 3B, the second portion 120 of the second engaging portion 116 may include three recesses 132 and four protrusions 134 on the second surface 124. The combination of the recesses 132 and protrusions 134 with the pressure of the recesses 132 and protrusions 134 or the lock 112 in general against the protrusions (not shown) on the battery chamber housing (not shown) may provide for a “click” latching feel when the second portion 120 moves relative to the battery chamber housing when the hearing aid user locks or unlocks the battery chamber housing. The “click” latching feel may provide an indication to the hearing aid user of the locking status when the hearing aid user locks or unlocks the battery chamber housing.

The second engaging portion 116 may include a plastic material or any other suitable material which may allow for configuring the second engaging portion 116 to include the plurality of recesses 126, 132 and protrusions 128, 134. The second engaging portion 116 may be a plastic material which may be molded to the desired shape. The second engaging portion 116 may also include any suitable material which may allow for printing of the marking 130 or for a change of a color of the material.

FIG. 4A shows a perspective view of a hearing aid 102 with close battery chamber housing 106 and with an exposed front view of a lock 112 positioned in the battery chamber housing 106 according to an embodiment, FIG. 4B shows a perspective view of an open battery chamber housing 106 and with an exposed top view of a lock 112 positioned in the battery chamber housing 106 according to an embodiment and FIG. 4C shows an open battery chamber housing 106 without the lock 112 according to an embodiment.

The hearing aid 102 may include a hearing aid housing 104, the hearing aid housing 104 including a receiving portion 110. The hearing aid 102 may further include a battery chamber housing 106 coupled to the hearing aid housing 104 and a lock 112 positioned on the battery chamber housing 106. The lock 112 may include a first engaging portion 114 and a second engaging portion 116 coupled to the first engaging portion 114. The first engaging portion 114 may include a material of a higher tensile strength than the second engaging portion 116. The first engaging portion 114 may be configured to be movable relative to the battery chamber housing 106 such that the first engaging portion 114 may be coupled to the receiving portion 110 to lock the battery chamber housing 106.

The first engaging portion 114 may include a cylindrical rod or an elongated portion of any other suitable shape. The first engaging portion 114 may include a metallic material or any other suitable material.

The second engaging portion 116 may include a first portion 118 and a second portion 120. The first portion 118 of the second engaging portion 116 may substantially surround the first engaging portion 114. The second portion 120 of the second engaging portion 116 may be positioned adjacent and/or in connection with the first portion 118 of the second engaging portion 116. The second portion 120 of the second engaging portion 116 may include a first surface 122 and a second surface 124, the second surface 124 being positioned opposite to the first surface 122.

From the exposed front view of the lock 112 positioned in the battery chamber housing 106 in FIG. 4A, the second portion 120 of the second engaging portion 116 may include two recesses 126 and three protrusions 128 on the first surface 122. The second portion 120 of the second engaging portion 116 may include a marking 130 on two of the three protrusions 128 on the first surface 122. One of the two recesses 126 may be positioned between the two protrusions 128 with markings 130 so as to provide an indication to the hearing aid user the position to insert a suitable device, for example a screw driver, in order to lock or unlock the battery chamber housing 106. The direction of the locking of the battery chamber housing 106 is as shown by the arrow 140 in FIG. 4A.

From the exposed top view of the lock 112 positioned in the battery chamber housing 106 in FIG. 4B, the second portion 120 of the second engaging portion 116 may include three recesses 132 and four protrusions 134 on the second surface 124.

The second engaging portion 116 may include a plastic material or any other suitable material which may allow for configuring the second engaging portion 116 to include the plurality of recesses 126, 132 and protrusions 128, 134. The second engaging portion 116 may be a plastic material which may be molded to the desired shape. The second engaging portion 116 may also include any suitable material which may allow for printing of the marking or for a change of a color of the material.

From FIG. 4C, the battery chamber housing 106 includes two protrusions 142 on a surface of the battery chamber housing 106. The number of protrusions may vary according to design or user requirements. The combination of the recesses 132 and protrusions 134 on the second surface 124 as shown in FIG. 4B with the pressure of the recesses 132 and protrusions 134 or the lock 112 in general against the protrusions 142 of the battery chamber housing 106 may provide for a “click” latching feel when the second portion 120 moves relative to the battery chamber housing 106 when the hearing aid user locks or unlocks the battery chamber housing 106. The “click” latching feel may provide an indication to the hearing aid user of the locking status when the hearing aid user locks or unlocks the battery chamber housing 106.

FIG. 5A shows a perspective view of a hearing aid 102 with close battery chamber housing 106 and a first recess 136 in the hearing aid housing 104 being a blind hole according to an embodiment and FIG. 5B shows a perspective view of a hearing aid 102 with close battery chamber housing 106 and a first recess 136 in the hearing aid housing 104 being a through hole according to an embodiment.

The hearing aid 102 may include a hearing aid housing 104, the hearing aid housing 104 including a receiving portion 110. The hearing aid 102 may further include a battery chamber housing 106 coupled to the hearing aid housing 104 and a lock 112 positioned on the battery chamber housing 106. The lock 112 may include a first engaging portion (now shown) and a second engaging portion 116 coupled to the first engaging portion. The first engaging portion may include a material of a higher tensile strength than the second engaging portion 116. The first engaging portion may be configured to be movable relative to the battery chamber housing 106 such that the first engaging portion may be coupled to the receiving portion 110 to lock the battery chamber housing 106.

The first engaging portion may include a cylindrical rod or an elongated portion of any other suitable shape. The first engaging portion may include a metallic material or any other suitable material.

The second engaging portion 116 may include a first portion 118 and a second portion 120. The first portion 118 of the second engaging portion 116 may substantially surround the first engaging portion. The second portion 120 of the second engaging portion 116 may be positioned adjacent and/or in connection with the first portion 118 of the second engaging portion 116. The second portion 120 of the second engaging portion 116 may include a first surface 122 and a second surface 124, the second surface 124 being positioned opposite to the first surface 122.

From the exposed front view of the lock 112 positioned in the battery chamber housing 106 in FIG. 5A and FIG. 5B, the second portion 120 of the second engaging portion 116 may include two recesses 126 and three protrusions 128 on the first surface 122. The second portion 120 of the second engaging portion 116 may include a marking 130 on two of the three protrusions 128 on the first surface 122. One of the two recesses 126 may be positioned between the two protrusions 128 with markings 130 so as to provide an indication to the hearing aid user the position to insert a suitable device, for example a screw driver, in order to lock or unlock the battery chamber housing 106.

The second engaging portion 116 may include a plastic material or any other suitable material which may allow for configuring the second engaging portion 116 to include the plurality of recesses 126, 132 and protrusions 128, 134. The second engaging portion 116 may be a plastic material which may be molded to the desired shape. The second engaging portion 116 may also include any suitable material which may allow for printing of the marking 130 or for a change of a color of the material.

The receiving portion 110 may include a first recess 136 and a second recess 138. The first recess 136 may be connected to the second recess 138. The second recess 138 may be of a larger surface area or dimension compared to the first recess 136 such that the first recess 136 may be situated within the second recess 138.

The first recess 136 may include a through hole or a blind hole. The first recess 136 may be of a circular shape or be of any suitable shape depending on design requirements. FIG. 5A shows the first recess 136 being a blind hole and FIG. 5B shows the first recess 136 being a through hole. The second recess 138 may include a slot or any suitable shape depending on design requirements.

The first engaging portion may be coupled to the first recess 136 and the second engaging portion 116 may be coupled to the second recess 138 when the lock 112 may be coupled to the receiving portion 110 to lock the battery chamber housing 106.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-22. (canceled)

23. A hearing aid, comprising:
a hearing aid housing formed with a receiving portion;
a battery chamber housing coupled to said hearing aid housing;
a lock positioned on said battery chamber housing, said lock including:
a first engaging portion and a second engaging portion coupled to said first engaging portion;
said first engaging portion being formed of a material having a greater tensile strength than a tensile strength of said second engaging portion; and
said first engaging portion being configured to be movable relative to said battery chamber housing such that said first engaging portion is being coupled to said receiving portion to lock said battery chamber housing.

24. The hearing aid according to claim 23, wherein said first engaging portion comprises a cylindrical rod.

25. The hearing aid according to claim 23, wherein said first engaging portion comprises a metallic material.

26. The hearing aid according to claim 23, wherein said second engaging portion comprises a first portion and a second portion.

27. The hearing aid according to claim 26, wherein said first portion of said second engaging portion substantially surrounds said first engaging portion.

28. The hearing aid according to claim 26, wherein said second portion of said second engaging portion comprises a first surface and a second surface, said second surface being positioned opposite said first surface.

29. The hearing aid according to claim 28, wherein said second portion of said second engaging portion is formed with at least one recess and at least one protrusion on said first surface.

30. The hearing aid according to claim 29, wherein said second portion of said second engaging portion is formed with a marking on said at least one protrusion on said first surface.

31. The hearing aid according to claim 28, wherein said second portion of said second engaging portion is formed with at least one recess and at least one protrusion on said second surface.

32. The hearing aid according to claim 23, wherein said second engaging portion is formed of a plastic material.

33. The hearing aid according to claim 23, wherein said receiving portion is formed with a first recess and a second recess.

34. The hearing aid according to claim 33, wherein said first recess is a through hole or a blind hole.

35. The hearing aid according to claim 33, wherein said second recess is a slot.

36. The hearing aid according to claim 33, wherein said first engaging portion is being coupled to said first recess and said second engaging portion is being coupled to said second recess when said lock is being coupled to said receiving portion to lock said battery chamber housing.

37. The hearing aid according to claim 23 formed as a behind-the-ear hearing aid.

38. The hearing aid according to claim 23, further comprising an ear hook coupled to said hearing aid housing.

39. The hearing aid according to claim 23, wherein said hearing aid housing is configured to receive said battery chamber housing.

40. The hearing aid according to claim 23, wherein said battery chamber housing is pivotally mounted to said hearing aid housing.

41. The hearing aid according to claim 23, wherein said battery chamber housing is formed with a partially circular outer shape.

42. The hearing aid according to claim 23, wherein said hearing aid housing is formed of a plastic material

43. The hearing aid according to claim 23, wherein said battery chamber housing is formed of a plastic material.

44. The hearing aid according to claim 23, wherein said hearing aid housing and said battery chamber housing are formed of a common material.
